(19) United States
(12) Patent Application Publication
(10) Pub. No.: US 2015/0166069 A1
(43) Pub. Date: Jun. 18, 2015

(54) AUTONOMOUS DRIVING STYLE LEARNING

(71) Applicant: FORD GLOBAL TECHNOLOGIES, LLC, DEARBORN, MI (US)

(72) Inventors: Gerald H. Engelman, PLYMOUTH, MI (US); ALEX MAURICE MILLER, CANTON, MI (US); THOMAS EDWARD PILUTTI, ANN ARBOR, MI (US); MATT Y. RUPP, CANTON, MI (US); RICHARD LEE STEPHENSON, ANN ARBOR, MI (US); LEVASSEUR TELLIS, SOUTHFIELD, MI (US); ROGER ARNOLD TROMBLEY, ANN ARBOR, MI (US); ANDREW WALDIS, ORION TOWNSHIP, MI (US); TIMOTHY D. ZWICKY, DEARBORN, MI (US)

(73) Assignee: FORD GLOBAL TECHNOLOGIES, LLC, DEARBORN, MI (US)

(21) Appl. No.: 14/133,284

(22) Filed: Dec. 18, 2013

(51) Int. Cl. B60W 40/00

(52) U.S. Cl. CPC B60W 40/00

(57) ABSTRACT

A vehicle includes at least one autonomous driving sensor configured to monitor at least one condition while the vehicle is operating in an autonomous mode. A processing device is configured to control at least one vehicle subsystem while the vehicle is operating in the autonomous mode. The processing device is configured to control the at least one vehicle subsystem according to a driver preference.

### BACKGROUND

Autonomous vehicles are becoming more sophisticated. As the level of sophistication increases, the amount of passenger interaction required by the autonomous vehicle decreases. Eventually, autonomous vehicles will require no passenger interaction beyond, e.g., selecting a destination, allowing all passengers to focus on non-driving-related tasks.

### BRIEF DESCRIPTION OF THE DRAWINGS

FIG. 1 illustrates an exemplary vehicle system that learns a driver's preferences for when the vehicle is operating in an autonomous mode.

FIG. 2 illustrates a flowchart of an exemplary process that may be implemented by the system of FIG. 1.

### DETAILED DESCRIPTION

A vehicle includes at least one autonomous driving sensor configured to monitor at least one condition while the vehicle is operating in an autonomous mode. A processing device is configured to control at least one vehicle subsystem while the vehicle is operating in the autonomous mode. The processing device is configured to control the at least one vehicle subsystem according to a driver preference. The driver preference may be learned while, e.g., the vehicle is operating in a non-autonomous mode.

The system shown in the FIGS. may take many different forms and include multiple and/or alternate components and facilities. While an exemplary system is shown, the exemplary components illustrated are not intended to be limiting. Indeed, additional or alternative components and/or implementations may be used.

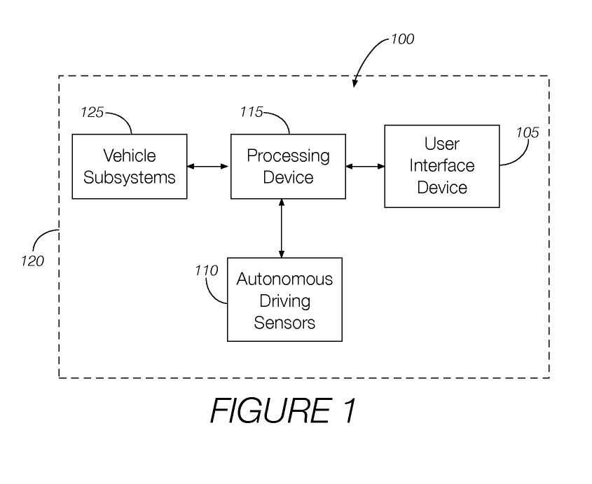

As illustrated in FIG. 1, the system 100 includes a user interface device 105, at least one autonomous driving sensor 110, and a processing device 115. The system 100 may be implemented in a vehicle 120 such as any passenger or commercial car, truck, sport utility vehicle, taxi, bus, train, airplane, etc.

The user interface device 105 may be configured to present information to a user, such as a driver, during operation of the vehicle 120. Moreover, the user interface device 105 may be configured to receive user inputs. Thus, the user interface device 105 may be located in the passenger compartment of the vehicle 120. In some possible approaches, the user interface device 105 may include a touch-sensitive display screen.

The autonomous driving sensors 110 may include any number of devices configured to generate signals that help navigate the vehicle 120 while the vehicle 120 is operating in an autonomous (e.g., driverless) mode. Examples of autonomous driving sensors 110 may include a radar sensor, a lidar sensor, a camera, an ultrasonic sensor, an energy-harvesting sensor, or the like. In some possible approaches, the autonomous driving sensors 110 may be configured to receive information from a remote source. Thus, the autonomous driving sensors 110 may further include cloud-based sensors such as a Dedicated Short Range Communication (DSRC) compliant device (802.11p), a cellular receiver, a WiFi receiver, or the like.

The autonomous driving sensors 110 help the vehicle 120 “see” the roadway and the vehicle surroundings and/or negotiate various obstacles while the vehicle 120 is operating in the autonomous mode. Moreover, the autonomous driving sensors 110 may be configured to monitor one or more conditions while the vehicle 120 is operating in autonomous or non-autonomous driving modes. Examples of conditions may include a roadway condition, an environmental condition, a traffic condition, or any combination of these and/or other types of conditions. Examples of roadway conditions may include a radius of road curvature, a road type, the number of lanes, the direction of traffic, the road grade, the type of lane, whether the road has a shoulder and if so the type of shoulder and the shoulder conditions, road speeds and regulations, intersection position, whether the intersection includes a control device, segment configuration, etc. Examples of environmental conditions may include the date, whether the current day is a weekend or holiday, the time of day, the current or pending lighting level, weather conditions (e.g., rain, snow, fog, mist, sleet, ice, or the like), etc. Examples of traffic conditions may include adjacent traffic proximity relative to the host vehicle 120, adjacent traffic classifications (e.g., whether adjacent traffic includes cars, trucks, pedestrians, motorcycles, etc.), adjacent traffic density and congestion levels, adjacent traffic speeds and acceleration information, etc.

The processing device 115 may be configured to control one or more subsystems 125 while the vehicle 120 is operating in the autonomous mode. Examples of subsystems 125 that may be controlled by the processing device 115 may include a brake subsystem, a suspension subsystem, a steering subsystem, and a powertrain subsystem. The processing device 115 may control any one or more of these subsystems 125 by outputting signals to control units associated with these subsystems 125. The processing device 115 may control the subsystems 125 based, at least in part, on signals generated by the autonomous driving sensors 110.

While the vehicle 120 is operating in the autonomous mode, the processing device 115 may be configured to control one or more vehicle 120 subsystems 125 according to one or more driver preferences. For example, the processing device 115 may, while the vehicle 120 is operating in the non-autonomous mode, learn various driver preferences, associate the learned driver preferences to predetermined scenarios, and apply the learned driver preference when the predetermined scenario occurs while the vehicle 120 is operating in the autonomous mode. If no driver preference is associated with a particular predetermined scenario, the processing device 115 may be configured to apply a default profile control for that scenario until a driver preference is learned. Examples of scenarios may include various combinations of the conditions described above. That is, each scenario may define a particular combination of roadway conditions, environmental conditions, and/or traffic conditions.

In some possible implementations, the processing device 115 may be configured to associate each learned driver preference to one or more profile controls, such as a longitudinal profile control, a lateral profile control, and a route profile control. The longitudinal profile control may define how the vehicle 120 operates in the autonomous mode when travelling longitudinally (e.g., in forward or reverse directions). The longitudinal profile control may include a speed profile control, a deceleration profile control, and an acceleration profile control. The speed profile control may define the speed of the vehicle 120, when operating in the autonomous mode, relative to a posted speed limit. The deceleration profile control may define how quickly the vehicle 120 decelerates when the vehicle 120 is operating in the autonomous mode, and the acceleration profile control may define how quickly the vehicle 120 accelerates when operating in the autonomous mode.

The lateral profile control may define how the vehicle 120 changes direction (e.g., turns and/or veers left or right) when operating in the autonomous mode. The lateral profile control may include, e.g., a steering profile control. The steering profile may define a driver preference for a steering wheel angle and rate of change during turns.

The route profile control may define how the vehicle 120 navigates a route when operating in the autonomous mode. The route profile control may include a position profile control, a lane choice profile control, and a road choice profile control. The position profile control may define the position of the host vehicle 120 relative to other vehicles, including the space between the host vehicle 120 and the target vehicle while both vehicles are moving and while both vehicles are stopped. The position profile control may further define the position of the host vehicle 120 within a lane. For instance, the position profile control may cause the vehicle 120 to generally travel in the center of the lane relative to one or more lane markers when operating in the autonomous mode. The road choice profile control may define particular roads used when planning routes. For instance, the road choice profile control may define a driver preference for favoring or avoiding highways, toll roads, bridges, tunnels, paved roads, gravel roads, etc.

In general, computing systems and/or devices, such as the processing device 115, may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

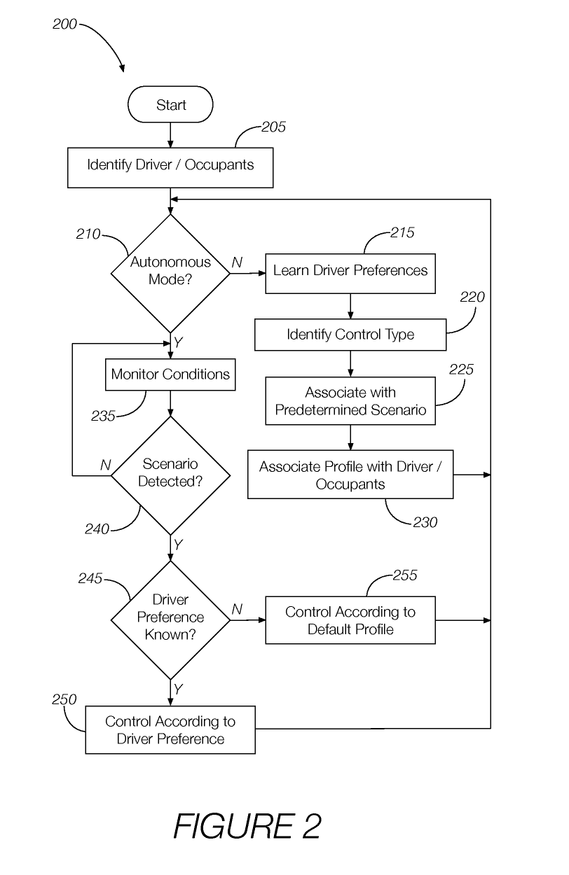

FIG. 2 is a flowchart of an exemplary process 200 that may be implemented by the system 100 of FIG. 1. For example, the process 200 may be implemented, in whole or in part, by, e.g., the processing device 115.

At block 205, the processing device 115 may identify the driver of the vehicle 120 and possibly other vehicle occupants. The processing device 115 may identify the driver based on a key used to start the vehicle 120 or an image of the driver and/or other occupants taken by a camera located in the passenger compartment of the vehicle 120.

At decision block 210, the processing device 115 may determine whether the vehicle 120 is operating in the autonomous mode. If the vehicle 120 is operating in a non-autonomous mode, the process 200 may continue at block 215. If the vehicle 120 is operating in the autonomous mode, the process 200 may continue at block 235.

At block 215, the processing device 115 may learn driver preferences. The driver preferences may relate to a longitudinal profile control, a lateral profile control, and a route profile control. The driver preferences may be learned while the vehicle 120 is operating in a non-autonomous mode.

At block 220, the processing device 115 may identify a control type related to the driver preference learned at block 215. Examples of control types may include the longitudinal control, the lateral control, and/or the route profile. As discussed above, the longitudinal profile control may define how the vehicle 120 operates in the autonomous mode when travelling longitudinally (e.g., in forward and/or reverse directions). The lateral profile control may define how the vehicle 120 changes direction (e.g., turns and/or veers left or right) when operating in the autonomous mode. The route profile control may define how the vehicle 120 navigates a route when operating in the autonomous mode.

At block 225, the processing device 115 may associate the learned driver preference to a predetermined scenario. Each scenario may define a particular combination of roadway conditions, environmental conditions, and/or traffic conditions. Generally, the learned driver preference may be associated with a scenario matching the roadway conditions, environmental conditions, and/or traffic conditions at the time the driver preference was learned.

At block 230, the processing device 115 may associate the learned driver preference with that particular driver so that in the future the vehicle 120 does not need to relearn the procedure. Additionally, the processing device 115 may make the distinction between associating the driver preference with the driver while they are driving in the vehicle alone with their preference of how they drive when they have other occupants in the vehicle 120. The process 200 may return to decision block 210 after block 230.

At block 235, the processing device 115 may monitor conditions such as the roadway conditions, environmental conditions, and traffic conditions. The processing device 115 may monitor such conditions based on signals received from one or more of the autonomous driving sensors 110. The process 200 may continue at block 240 after block 235.

At decision block 240, the processing device 115 may determine or check whether any predetermined scenarios have been detected based on, e.g., whether any of the conditions monitored at block 235 define any predetermined scenarios. If a predetermined scenario is detected, the process 200 may continue at block 245. If no predetermined scenarios are detected at block 240, the process 200 may return to block 235 to continually monitor the conditions.

At decision block 245, the processing device 115 may determine whether the driver preference is known for the predetermined scenario detected at decision block 240. If a driver preference is known, the process 200 may continue at block 250. If no driver preference is known for the detected predetermined scenario, the process 200 may continue at block 255.

At block 250, the processing device 115 may control at least one subsystem according to the driver preference associated with the detected predetermined scenario. Thus, the processing device 115 may apply the driver preferences for, e.g., longitudinal and lateral control of the vehicle 120 while operating in the autonomous mode. The process 200 may return to decision block 210 after block 250.

At block 255, the processing device 115 may apply a default profile control if there are no driver preferences associated with the detected predetermined scenario. The default profile control may be based on one or more calibration settings. The process 200 may return to decision block 210 after block 255.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle comprising:
at least one autonomous driving sensor configured to monitor at least one condition while operating in an autonomous mode; and
a processing device configured to control at least one vehicle subsystem while operating in the autonomous mode,
wherein the processing device is programmed to learn at least one driver preference and associate at least one of the learned driver preferences to a predetermined scenario when the vehicle is operating in a non-autonomous mode, and,
while the vehicle is operating in the autonomous mode, the processing device is programmed to:
detect the predetermined scenario,
determine whether any of the at least one driver preferences is associated with the detected predetermined scenario,
select one of the at least one driver preference and a default profile control after detecting the predetermined scenario, and
apply one of the at least one driver preference and the default profile control to control the at least one vehicle subsystem.

2. (canceled)

3. (canceled)

4. (canceled)

5. The vehicle of claim 1, wherein the processing device is configured to select and apply the default profile control when no driver preference is associated with the detected predetermined scenario.

6. The vehicle of claim 1, wherein the condition monitored by the autonomous driving sensor includes at least one of a roadway condition, an environmental condition, and a traffic condition.

7. The vehicle of claim 1, wherein the processing device is configured to associate the at least one driver preference to at least one of a longitudinal profile control, a lateral profile control, and a route profile control.

8. The vehicle of claim 7, wherein the longitudinal profile control includes at least one of a speed profile control, a deceleration profile control, and an acceleration profile control.

9. The vehicle of claim 7, wherein the lateral profile control includes a steering profile control.

10. The vehicle of claim 7, wherein the route profile control includes a position profile control, a lane choice profile control, and a road choice profile control.

11. The vehicle of claim 10, wherein the position profile control is based at least in part on at least one driver preference associated with at least one of a position of the vehicle relative to a target vehicle and a position of the vehicle relative to a lane marker.

12. A method comprising:
learning at least one driver preference associated with operating a vehicle in a non-autonomous mode;
associating the at least one driver preference to a predetermined scenario while the vehicle is operating in the non-autonomous mode; and
while the vehicle is operating in an autonomous mode:
detecting the predetermined scenario,
determining whether at least one of the driver preferences is associated with the detected predetermined scenario,
selecting one of the at least one driver preference and a default profile control after detecting the predetermined scenario, and
controlling at least one vehicle subsystem according to one of the at least one driver preference and the default profile control.

13. The method of claim 12, further comprising applying the default profile control if no driver preference is associated with the detected predetermined scenario.

14. The method of claim 12, further comprising monitoring a condition while the vehicle is operating in the autonomous mode, wherein the condition includes at least one of a roadway condition, an environmental condition, and a traffic condition.

15. The method of claim 12, further comprising identifying a control type associated with the at least one driver preference, the control type including at least one of a longitudinal profile control, a lateral profile control, and a route profile control.

16. The method of claim 15, wherein the longitudinal profile control includes at least one of a speed profile control, a deceleration profile control, and an acceleration profile control.

17. The method of claim 15, wherein the lateral profile control includes a steering profile control.

18. The method of claim 15, wherein the route profile control includes a position profile control, a lane choice profile control, and a road choice profile control.

19. The method of claim 18, wherein the position profile control is based at least in part on a driver preference associated with at least one of a position of the vehicle relative to a target vehicle and a position of the vehicle relative to a lane marker.

20. A vehicle comprising:
at least one autonomous driving sensor configured to monitor at least one condition while operating in an autonomous mode; and
a processing device configured to learn at least one driver preference when the vehicle is operating in a non-autonomous mode and associate the at least one learned driver preference with a predetermined scenario,
wherein, when operating in the autonomous mode, the processing device is configured to:
detect the predetermined scenario,
determine whether any of the at least one driver preferences is associated with the detected predetermined scenario,
select one of the at least one driver preference and a default profile control after detecting the predetermined scenario, wherein the processing device is programmed to select the at least one driver preference if the at least one driver preference is associated with the detected predetermined scenario and wherein the processing device is programmed to select the default profile control if no driver preference is associated with the detected predetermined scenario, and
apply one of the selected learned driver preference and the selected default profile control.
